(19) United States
(12) Patent Application Publication
(10) Pub. No.: US 2011/0199027 A1
(43) Pub. Date: Aug. 18, 2011

(54) ELECTRON BEAM GENERATOR HAVING ADJUSTABLE BEAM WIDTH

(76) Inventor: Yong Hwan Kim, Gyeonggi-do (KR)

(21) Appl. No.: 13/124,816

(22) PCT Filed: Oct. 16, 2009
(86) PCT No.: PCT/KR2009/005985

§ 371 Date: Apr. 18, 2011

(30) Foreign Application Priority Data
Oct. 16, 2008 (KR) 10-2008-0101700
Oct. 16, 2009 (KR) 10-2009-0098807

(51) Int. Cl. H01J 29/56

(52) U.S. Cl. 315/370

(57) ABSTRACT

The present invention relates to an electron beam generator with an adjustable beam width. Said electron beam generator comprises: a plasma generating chamber that generates and sustains plasma; an RF power-generating antenna disposed on the outer circumference of said plasma generating chamber; a primary grid mounted on the outlet of said plasma generating chamber; a secondary grid placed at a fixed distance away from said primary grid; a beam width controller comprising an inlet, an outlet and a hollow inside, wherein the inlet is located on the side of said secondary grid, and the electron particles introduced through said inlet form electron beams of a pre-set beam width and are discharged through said outlet; and an RF shield ring disposed to surround the outer circumference of the inlet of said beam width controller. In the electron beam generator of the present invention, the electron particles discharged from said plasma generating chamber are delivered in the form of electron beams of a preset beam width to the outlet of said beam width controller.

### TECHNICAL FIELD

The present invention relates to an electron beam generator, and more particularly, to an electron beam generator which focuses or defocuses an electron beam with an adjustable beam width and voluntarily adjusts the size of the electron beam to emit such electron beam to a large area.

### BACKGROUND ART

Generally, an electron gun accelerates, focuses and emits thermoelectron generated from a filament in a vacuum. The electron gun is used in a cathode ray tube (CRT) emitting an electron beam to generate a thermoelectron from the filament, accelerate the thermoelectron at an ultrahigh speed for emission to a screen having a fluorescent material applied thereto. Accordingly, the electron beam used in the CRT is a very small size. Other types of electron guns heat a tungsten filament in a vacuum and accelerate and emit a thermoelectron generated from the tungsten filament to a metal or an oxide in a small container, wherein the material dissolves and is vaporized. Such electron guns are used in depositing a thin film on a glass lens, plastic, semiconductor wafer or glass. Another electron gun which has high energy and needs a small beam size is used in various analysis devices such as a scanning electron microscope (SEM), a transmission electron microscope (TEM), and an auger electron spectroscopy (AES).

As above, the conventional electron gun emits a beam having high energy generated from the heated filament to a small area, and is hardly applicable to the case when the electron beam should be uniformly emitted to a large area. In the electron generating method, heating the filament for generating the thermoelectron is easy and efficient, but the filament is easily broken after being heated due to embrittlement and becomes thin and broken due to oxidization if being heated in the oxygen atmosphere. If the filament extends to several meters and receives power to emit an electron beam to a large area such as an LCD glass, the electron beam does not remain uniform due to a droop.

Accordingly, the present invention provides a method for generating an electron beam with a uniform density by uniformly making plasma in large size and extracting and accelerating electrons only from the plasma, without using a filament.

### DISCLOSURE

### [Technical Problem]

The present invention has been made to solve the problems and it is an object of the present invention to provide an electron beam control device in a circular shape which controls a beam width of an electron beam emitted to a substrate, an intensity of flux and energy of the electron beam.

Also, it is another object of the present invention to provide an electron beam control device which controls a beam width of an electron beam and/or intensity of flux and energy of the electron beam when a rectangular electron beam is emitted to a large substrate to process the substrate.

### [Technical Solution]

In order to achieve the object of the present invention, an electron beam generator comprises a plasma generating chamber which comprises a gas inlet and outlet and generates and sustains plasma by using the gas supplied through the gas inlet; an antenna which is disposed in an outer circumference of the plasma generating chamber and supplies RF power; a primary grid which is mounted in the outlet of the plasma generating chamber; a secondary grid which is spaced from the primary grid at a predetermined interval; a beam width controller which comprises an inlet, an outlet and a hollow unit therein, and the inlet is disposed in the secondary grid, forms an electron beam with a beam width set in advance by electron particles introduced through the inlet, and the plasma generating chamber, the primary grid, the secondary grid and the beam width controller being arranged on the same axis, and the power applied to the primary grid and the secondary grid to form a potential difference to accelerate electrons, and electron particles being extracted from the plasma generating chamber to be supplied to the outlet of the beam width controller in an electron beam with a preset beam width.

The electron beam generator further comprises an RF shield ring which is disposed in an outer circumference of the inlet of the beam width controller by surrounding the outer circumference of the inlet of the beam width controller and comprises a ferromagnetic material.

In the electron beam generator, the plasma generating chamber comprises an internal wall and an external wall spaced from the internal wall at a predetermined interval, and the internal wall and the external wall comprise a dielectric, and the internal wall comprises a plurality of openings formed in a vertical direction of the antenna.

In the electron beam generator, the antenna has a surface applied with an insulating material.

The electron beam generator further comprises a cooling unit which is provided in a location contacting a lateral side of the RF shield ring.

In the electron beam generator, the secondary grid comprises a single step or multi-steps.

The electron beam generator further comprises at least one electrode terminal provided in an internal surface of the beam width controller, wherein the beam width controller comprises an insulating material, and adjusts a voltage applied to the electrode terminals to control a beam width of an electron beam.

The electron beam generator further comprises an electrode terminal which is connected to the beam width controller, wherein the beam width controller comprises a conductive material and adjusts a voltage applied to the electrode terminal to control a beam width of an electron beam.

The electron beam generator further comprises a floating grid which is provided between the secondary grid and the beam width controller and is insulated electrically.

In the electron beam generator, the plasma generating chamber is shaped like a cylinder, and the antenna is coiled several times in an outer circumference of the plasma generating chamber, and the plasma generating chamber is shaped like a polygon and the antenna is bent and coiled in an external surface of the plasma generating chamber in a lengthwise direction of the plasma generating chamber.

### [Advantageous Effect]

An electron beam generator according to the present invention adjusts a flow of electron particles using a beam with controller to thereby control a beam width of an electron beam emitted and/or an intensity of flux and energy of the electron beam. Accordingly, the electron beam generator according to the present invention not only controls plasma on a substrate created by electrons but also adjusts the emission area of the electron beam with respect to the substrate and controls the flux on the substrate and ultimately maximize the effect of the substrate from the emission of the electron beam since it can focuses or extends a beam width for emission whether the electron beam be shaped like a circle or a rectangle. Accordingly, the electron beam generator according to the present invention, among others, a rectangular electron beam generator may emit an electron beam easily and stably in a large area as a scan direction of the electron beam is perpendicular to a major axis of the beam.

If a rectangular electron beam is generated in several meters corresponding to an LCD glass by the electron beam generator according to the present invention, the entire large-sized substrate may be treated by the electron beam by moving the electron beam source in a perpendicular direction of the major axis of the rectangle or by moving the substrate. To obtain a desired result via emission of the electron beam to the substrate and an effect to a substrate material, the electron beam energy as a collision speed of the electron beam and flux as the number of colliding electron particles per unit time and unit area should be properly controlled.

FIG. 16 is a graph which illustrates a flux of an electron beam emitted by the electron beam generator according to the present invention. In the graph, the current density which is measured by using faraday cup and represents flux per unit time and unit area is shown with vary energy of the electron beam extracted from the plasma, if Ar gas of 8 sccm is supplied in the case when RF power of 200 W and 300 W is applied to a quartz chamber within the electron beam source to generate plasma from which the electron beam is extracted. The faraday cup refers to a measured electron beam from the electron beam source that is 30 cm ahead. As in FIG. 16, the more the electron beam energy and RF power are, the more the current density of the emitted electron beam is.

### BRIEF DESCRIPTION OF DRAWINGS

FIG. 1 is an exploded perspective view of an electron beam generator according to a first exemplary embodiment of the present invention.

FIG. 2 is a perspective view and a sectional view of a plasma generating chamber of the electron beam generator according to the first exemplary embodiment of the present invention

FIG. 3 is a perspective view and a sectional view of an antenna 30 which is used in the electron beam generator according to the present invention.

FIG. 4 is a front view and a sectional view of a primary grid and a secondary grid of the electron beam generator according to the present invention.

FIG. 5 is sectional views of an operating process of the electron beam generator.

FIG. 6 is a sectional view of a beam width controller 70 of the electron beam generator according to the present invention.

FIG. 7 is a sectional view of another beam width controller 70 of the electron beam generator according to the present invention.

FIG. 8 illustrates controlled beam width according to a negative voltage bias applied by a variable voltage supply means 80.

FIG. 9 is a sectional view of another beam width controller 70 of the electron beam generator according to the present invention.

FIG. 10 illustrates electrode terminals which receive different voltages.

FIG. 11 illustrates grids of an electron beam generator according to another exemplary embodiment of the present invention.

FIG. 12 is an exploded perspective view of an electron beam generator according to a second exemplary embodiment of the present invention.

FIG. 13 is a perspective view and a sectional view of a plasma generating chamber of the electron beam generator according to the second exemplary embodiment of the present invention.

FIG. 14 is a perspective view of an antenna which is mounted in the plasma generating chamber of the electron beam generator according to the second exemplary embodiment of the present invention.

FIG. 15 illustrates a gas inlet with a multi-step structure to uniformly supply gas in a lengthwise direction from the plasma generating chamber of the electron beam generator according to the second exemplary embodiment of the present invention.

FIG. 16 is a graph which illustrates flux of an electron beam emitted by the electron beam generator according to the present invention.

### DESCRIPTION OF NUMERALS FOR MAJOR PARTS IN THE DRAWINGS

2, 3: Electron beam generator
20: Plasma generating chamber
30: RF antenna
40: Primary grid
50: Secondary grid
52: Grid supporting ring
60: Beam width controller
80: Cooling unit
70: RF shield ring

### BEST MODE

Hereinafter, exemplary embodiments of the present invention will be described in detail with reference to drawings.

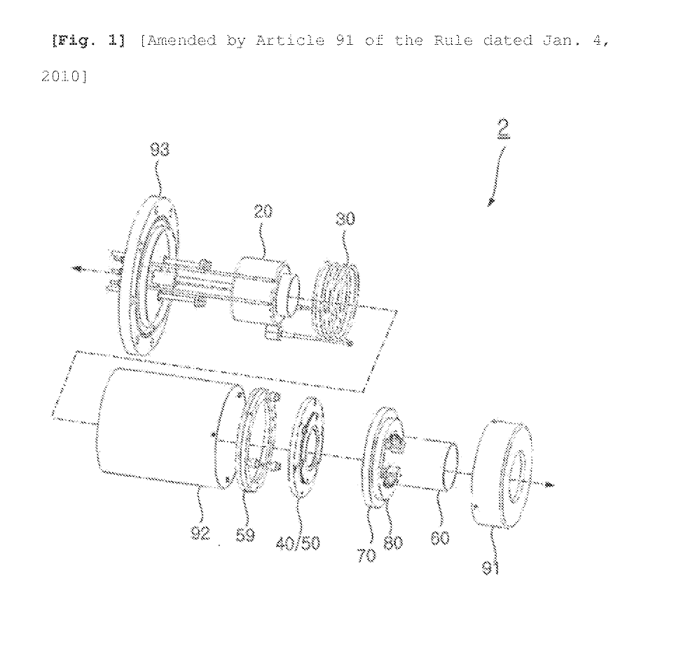

FIG. 1 is an exploded perspective view of a circle-shaped electron beam generator according to a first exemplary embodiment of the present invention. Referring to FIG. 1, an electron beam generator 2 according to the present exemplary embodiment includes a plasma generating chamber 20, a radio frequency (RF) antenna 30, a grid support ring 52 to which a primary grid 40 and a secondary grid 50 are fixed, a beam width controller 60, an RF shield ring 70 which is cooled by a cooling water supplied to a cooling unit 80, housing units 91 and 92 and a flange 93 which supplies power, gas and cooling water to a vacuum chamber. The electron beam generator 2 extracts electron particles from an RF plasma generated within the plasma generating chamber and emits an electron beam to an outlet of the beam width controller 60. The plasma generating chamber 20 contacts the primary grid 40 of the grid supporting ring 52 insulated and provided on a housing flange 59, and the secondary grid 50 and the beam width controller 60 are sequentially arranged. Hereinafter, configurations and operations of the foregoing elements will be described.

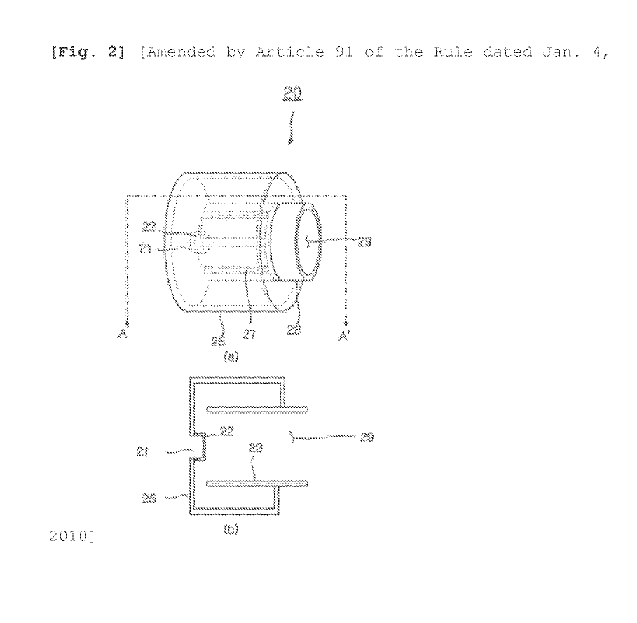

The plasma generating chamber 20 is shaped like a cylinder as a whole, and includes quartz or a dielectric such as Pyrex. FIG. 2 is a perspective view and a sectional view of the plasma generating chamber 20 of the electron beam generator 2 according to the present embodiment. Referring to FIG. 2, the plasma generating chamber 20 includes a depressed unit 21 formed in the inlet, a gas inlet 22 formed in a lateral side of the depressed unit 21, an internal wall 23 and an external wall 25. The internal wall 23 and the external wall 25 are spaced from each other at a predetermined interval, and an end part of the external wall 25 is coupled to an outer circumference of the internal wall 23. The internal wall 23 includes a plurality of openings 27 which is formed in the lengthwise direction of the plasma generating chamber 20 inside the external wall 25. Hereinafter, structural characteristics of the plasma generating chamber 20 of the electron beam generator 2 according to the present invention as shown in (b) in FIG. 2 will be compared with a conventional plasma generating chamber excluding an internal wall.

The conventional plasma generating chamber includes an external wall without an internal wall. Such conventional chamber includes an electrode surface toward plasma in the RF antenna, plasma within the chamber, capacitive plasma in a relationship with a metal electrode (primary grid) to apply an electric potential. Thus, if the electric potential increases against the metal electrode, the metal electrode is sputtered and contaminates the wall of the plasma generating chamber to shield external RF power. Then, the RF inductive plasma is not generated from the chamber and the electron beam disappears.

However, the electron beam generator 2 according to the present invention has the opening 27 in a slot shape within the internal wall 23 and separates plasma of the chamber to the internal plasma and external plasma. As a result, an impedance between a metal surface of the RF antenna 30 and a metal surface of the primary grid 40 increases to reduce a direct capacitive component, and the plasma within the internal wall 23 floats by high pressure to thereby generate an electron beam with high energy. Then, a cleaning period of the electron beam due to contamination may extend drastically, and the electron beam energy increases highly. Such plasma chamber may be also applicable to an ion source.

In the case of the gas inlet 22 in (b) in FIG. 2, if a gas tube is open toward the plasma within the chamber, the gas introduced by the inlet directly contacts the plasma within the chamber and causes an ark around the gas inlet 22, and a high voltage of 3 kV or more may not be applied to the primary grid 40.

To solve the foregoing problem, the plasma generating chamber 20 is formed by the internal wall 23 and the external wall 25 which are spaced from each other at a predetermined interval. Then, a conductive material is not applied to the external wall to generate plasma, and usage time of the plasma generating chamber 20 and efficiency of the plasma increases. As shown in (b) in FIG. 2, the plasma generating chamber 20 according to the present invention has the depressed unit 21 formed in the inlet and a through hole formed in a lateral side to form the gas inlet 22. As gas is supplied through the gas inlet formed in the lateral side of the depressed unit 21, plasma does not directly contact the supplied gas. The application of the plasma generating chamber 20 with the foregoing configuration may solve all of the conventional problems.

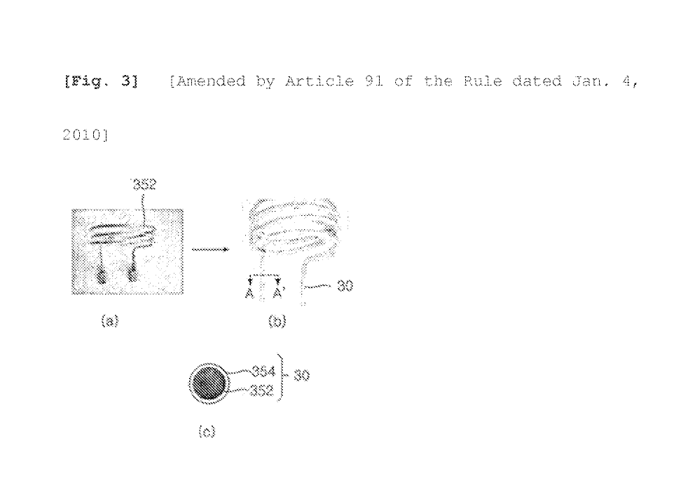

FIG. 3 is a perspective view and a sectional view of the RF antenna 30 of the electron beam generator 2 according to the present invention. Referring to FIG. 3, the RF antenna 30 has a coating layer 354 including an insulating material and provided on a surface of an antenna 352 including copper, stainless steel or metal. A cooling water path is provided in the surface of the RF antenna 30 for cooling. The coating layer 354 includes fluoroplastic such as PTFE, PFA, FED and PVDF or an insulating ceramic material such as alumina, zirconia, silicon nitride and AIN. The RF antenna 30 is coiled several times around an outer circumference of the plasma generating chamber 20 and supplies RF power to the plasma generating chamber 20. (a) in FIG. 3 illustrates the antenna 352 before coating, and (b) in FIG. 3 illustrates the antenna 352 having the coating layer applied thereto. The coated antenna is provided for generating plasma and the coating layer on a surface of the copper antenna may improve efficiency of the plasma. (c) in FIG. 3 is a sectional view taken along line A-A′, which illustrates a section of the antenna having an insulating material applied thereto.

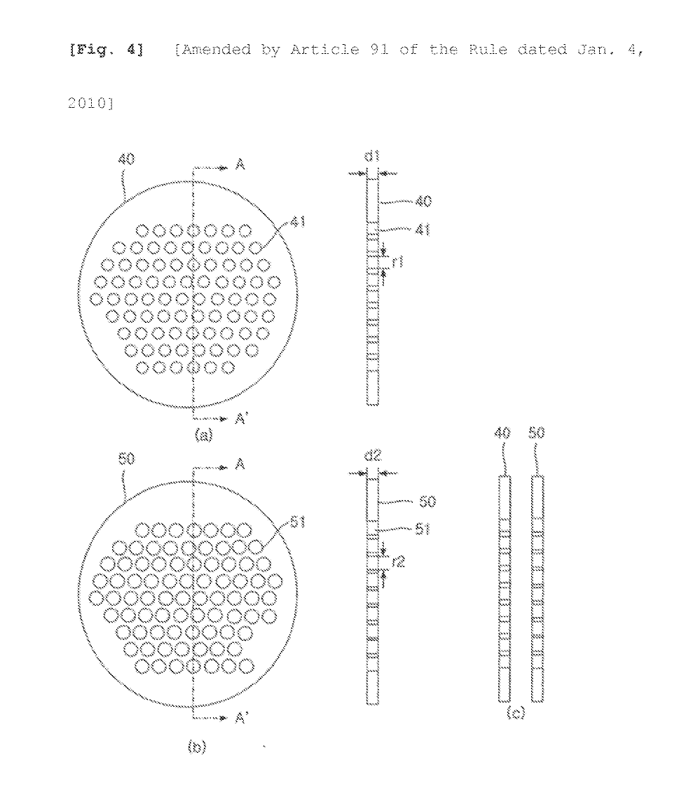

FIG. 4 is a front view and a sectional view of the primary grid and the secondary grid of the electron beam generator 2 according to the present invention. Referring to (a) and (b) in FIG. 4, the primary grid 42 and the secondary grid 52 include Si, Mo, Ti, graphite and W. The primary grid 42 includes a plurality of primary through holes 41, and the secondary grid 52 includes a plurality of secondary through holes 51. As shown in (c) in FIG. 4, the primary and secondary grids 42 and 52 are arranged sequentially so that the primary through holes 41 and the secondary through holes 51 maintain a predetermined space therebetween. An internal diameter r1 of the primary grid 42 is 1.5 mm or less, and the ratio of a thickness d1 to the internal diameter r1 is preferably 1 or less. The thickness of the secondary grid 52 is 1.5 mm or less, and the ratio of a thickness d2 to the internal diameter r2 of the through holes is preferably 1 to 1.2. When the electron beam generator 2 according to the present exemplary embodiment is driven, the primary grid 42 is biased negatively, and the secondary grid 52, as an accelerator grid, is biased positively or connected to the ground to form a potential difference from the primary grid 41.

The beam width controller 60 in FIG. 1 has a cylindrical shape whose inside is hollow. The inlet of the beam width controller 60 is adjacently provided to the secondary grid 52 so that electron particles are introduced to the inside of the beam width controller 60 to the outlet through the through holes 51 of the secondary grid 52. The internal surface of the beam width controller 60 is electrically insulated or biased negatively to control the size of the beam width, and focuses and defocuses the beam. Preferably, the ratio of the diameter of the beam width controller 60 to the beam width is 1 to 1.5.

The RF shield ring 70 in FIG. 1 includes a ferromagnetic substance, and surrounds an outer circumference of the beam width controller 60 and is mounted in the outer circumference of the inlet of the beam width controller 60. The RF shield ring 70 is disposed between the antenna 30 and the beam width controller 60 to shield RF power from the antenna from being transmitted to the beam width controller 60.

A first side of the RF shield ring 60 contacts the cooling unit 80, which is connected to an external cooling device. Thus, a cooling material such as cooling water, cooling oil or cooling gas is supplied to the cooling unit 80 by the cooling device and circulates the cooling unit 80 to thereby prevent the temperature of the RF shield ring 60 from rising. The cooling device may be used by other methods than the cooling water or cooling oil.

With the foregoing configuration, an operation of the electron beam generator 2 will be described.

In FIG. 1, gas such as argon is supplied to the inside of the plasma generating chamber 20 through the gas inlet 22, and RF power is applied to the antenna 30 surrounding the outside of the plasma generating chamber 20. The argon gas within the plasma generating chamber 20 is dissociated by the RF power and becomes quasi-neutral plasma including argon cation Ar+, argon atom and electrons e−. The particles within the plasma float and have negative potential by negative potential applied to the primary grid 42 contacting the plasma. Among such particles, electrons are extracted from plasma phase by the secondary grid 52 as a positive potential compared to the electric potential of the primary grid 42. The extracted electrons are accelerated in proportion to the potential difference between the primary grid 42 and the secondary grid 52. The electrons accelerate through the primary through holes and the secondary through holes and form a number of electron beams in one direction. The electron beams integrate into a single electron beam with a relatively wide width and high flux to be emitted through the beam width controller 60.

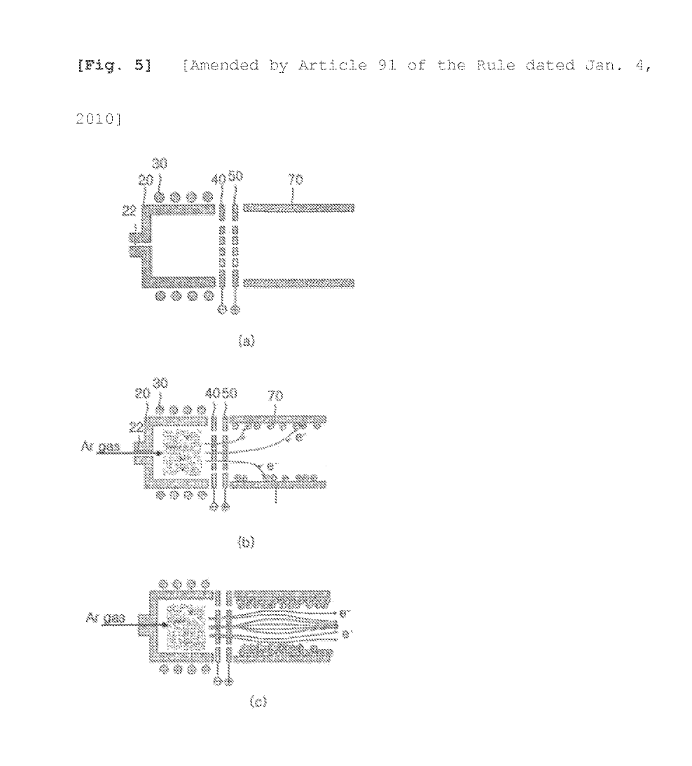

(a) and (b) in FIG. 5 are sectional views of the electron beam generator 2 for its operation. Referring to FIG. 5, the role of the beam width controller 60 of the electron beam generator 2 according to the present invention will be described. (a) in FIG. 5 is a sectional view of a main part of the electron beam generator 2 to illustrate an operation of the electron beam generator 2 according to the present invention.

In (b) in FIG. 5, if the gas is supplied to the plasma generating chamber 20 through the gas inlet 22 and the power is supplied to the RF antenna 30 by the foregoing method, plasma is generated and electron particles are discharged through the outlet via the beam width controller 60 by the electric potential applied to the primary grid 40 and the secondary grid 50. Part of the electron beam disappears by the secondary grid 50, but a considerable amount of electron beams passes the inside of the beam width controller 70. The electron beam tends to diffuse in a radial shape due to a space charge effect having a repulsive force in the space. Part of electron beams collides with the internal surface of the beam width controller 60 due to the repulsive force. As all of the beam width controller 60 or at least the inside thereof is insulated, the electrons colliding with the inside of the beam width controller 60 are accumulated therein. (b) in FIG. 5 illustrates such accumulation of the electrons. If the accumulation of the electrons begins, electric force therefrom affects a trajectory of subsequent electrons. That is, the subsequent electrons flowing inside of the beam width controller 60 receive a repulsive force from all directions, and overcome the space charge effect within the space, gather in the center of the beam width controller 60 and are emitted to the target as the electron beam.

Accordingly, if the electrons continue to be accumulated inside the beam width controller 60 and an absolute value of the electric potential of the accumulated electrons keeps rising, the electron beams are not refracted inside the beam width controller 60 due to such electric potential, and keep a balance, at a particular critical value or more, between the repulsive force of the electron beams and the repulsive force accumulated inside the beam width controller 60 and move in a direction in parallel with the beam width controller 60. Then, the trajectory of the electron beam is adjusted and the electron beams which are emitted through the beam width controller 60 stably reach the target with a relatively massive amount of flux across the space.

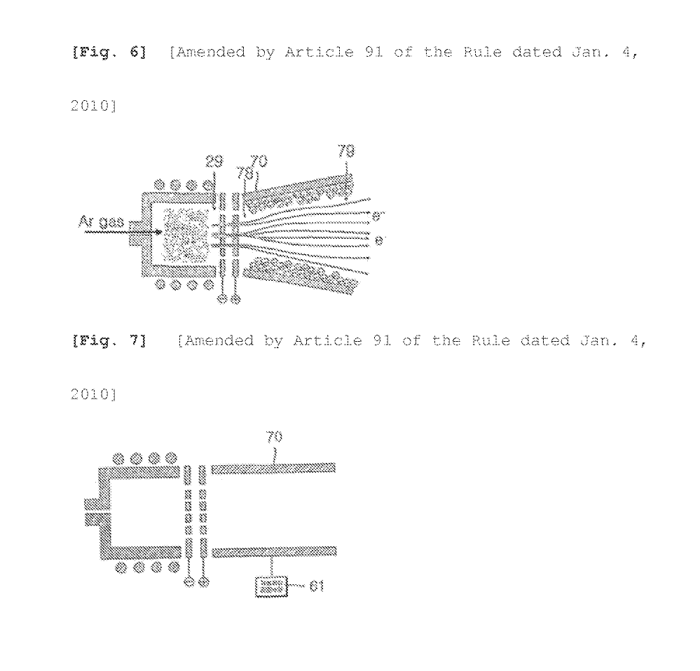

FIG. 6 is a sectional view of another beam width controller 70 according to the present invention. As shown therein, if a diameter of an outlet 79 of the beam width controller 70 is larger than a diameter of an inlet 78 to which the electron beam is supplied, electron particle flux may be emitted to a larger area than an outlet 29 of the plasma generating chamber 20.

If the diameter of the outlet of the beam width controller 70 is smaller than the diameter of the inlet, electron particle flux with a relatively narrower beam width may be emitted. Thus, such beam may be used to process a surface with a more precise and compact electron beam density. As described above, the electron beam generator 2 according to the present exemplary embodiment of the present invention controls a beam width by using a shape of the beam width controller 70.

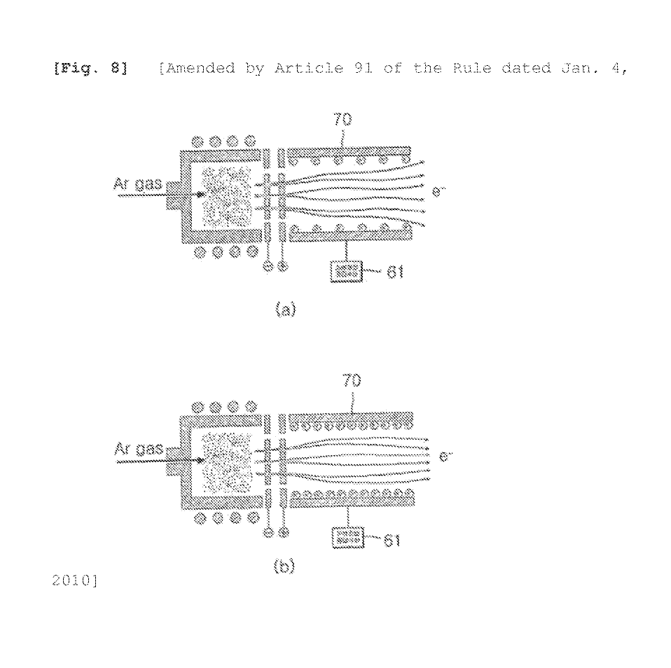

FIG. 7 illustrates another beam width controller 70 of the electron beam generator according to the present invention. Referring to FIG. 7, a negative voltage is applied to the beam width controller 70 including a conductive material through a variable voltage supply means 61 to electrically control a beam width or a flux per unit area. The beam width controller 70 may easily control the intensity of the negative voltage bias applied by the variable voltage supply means 61 and a beam width.

FIG. 8 is sectional views for comparison of control of a beam width by the negative voltage bias applied by the variable voltage supply means 80. (a) in FIG. 8 illustrates the case when the negative voltage bias applied to the beam width controller 70 is smaller than a reference value. (b) in FIG. 8 illustrates the case when the negative voltage bias applied to the beam width controller 70 is larger than the reference value. The reference value refers to a voltage bias when the beam width moves horizontally, and such reference value depends on the length of the beam width controller 70 and the intensity of the electron beam.

As shown in FIG. 8, if the negative voltage bias which is larger than the reference value is applied to the beam width controller 70, electron beams gather in the center more in (b) than in (a) to form a narrower beam width and change a beam flux per unit area.

Accordingly, in the present exemplary embodiment, the beam width or beam flux may be adjusted by controlling the size of the negative voltage bias applied to the beam width controller 70 unlike in the exemplary embodiment in FIG. 6. The beam width controller 70 in a cylindrical shape relates to the length of the cylinder. That is, even if the same negative voltage is applied, the length of the space receiving the negative voltage is changed by the length of the cylinder and the trajectory of the electrons may be further focused or over-focused when passing the negatively-charged electrode in a longer space. Thus, the cylindrical electrode of the beam width controller 70 controls the size of the beam width reaching the target by the length of the cylinder and the intensity of the electric potential of the electrode applied when the flying speed is set by a predetermined electron energy. The appropriate length of the cylinder according to the present invention is approximately 7 cm, which may vary as necessary.

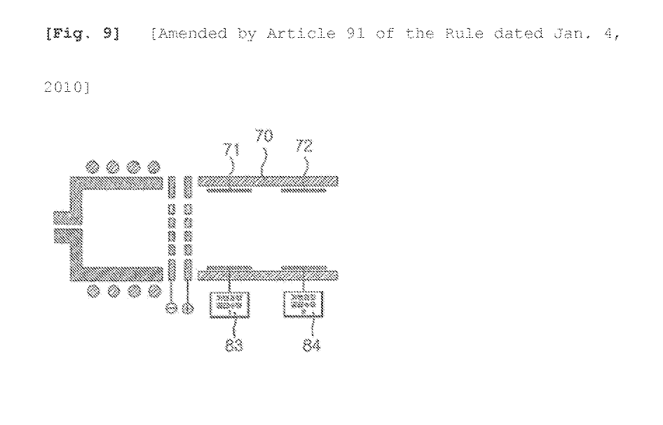

FIG. 9 is a sectional view of another beam width controller 70 of the electron beam generator 2 according to the present invention. Referring to FIG. 9, the beam width controller 70 according to the present exemplary embodiment has a plurality of electrode terminals 71 and 72 provided in a lengthwise direction therein. The electrode terminals 71 and 72 are connected to the variable voltage supply means to electrically control the flux per unit area. The electrode terminals 71 and 72 are formed in a smaller ring than an internal diameter of the beam width controller 70, and are spaced from an inner circumference of the beam width controller 70 at a predetermined interval. The electrode terminals 71 and 72 may include a conductive material such as a metal, and are connected to variable voltage supply means 83 and 84. A single ring-shaped electrode may be provided, or preferably at least one or more electrodes may be provided in a lengthwise direction of the beam width controller 70. FIG. 9 illustrates sections of the electrode terminals 71 and 72.

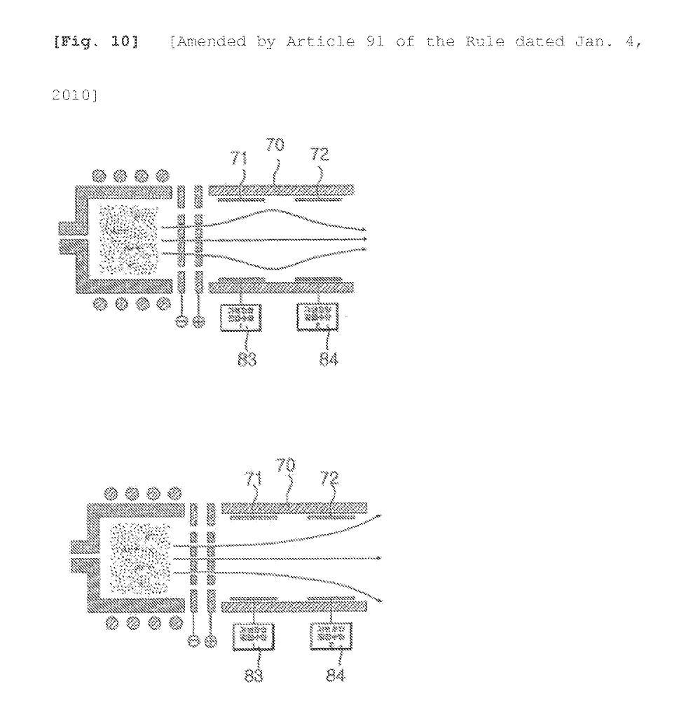

A bias voltage of the ring-shaped electrode terminals 71 and 72 is controlled independently. FIG. 10 illustrates electrode terminals which receive different voltages. Typically, the first electrode terminal 71 and the second electrode terminal 72 connect the same electric potential, and the beam width controller 70 generates a different electric potential with a variable voltage supply means to control a flying path of electron beams. The change in the electric potential varies the flow or trajectory of electrons to thereby control the beam width and/or flux density meeting the target of the electron beam. The beam width controller 70 of the electron beam generator 2 according to the foregoing embodiments of the present invention controls the flow of the electron particles to stably emit the flux of the electron particle beam to a relatively larger area or control the width of the electron particle beam.

In the present invention, there should be a voltage difference between the primary grid and the secondary grid to accelerate the electron particles. However, if a voltage difference between the two grids is too large, an ark is caused between the grids or other problems may occur. Hereinafter, various solutions to such problems will be described.

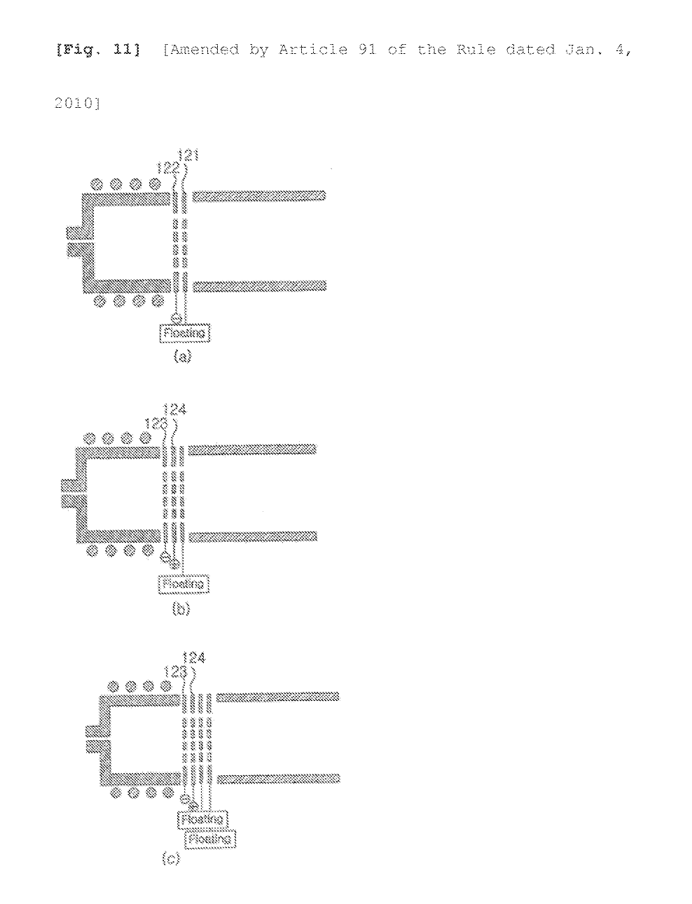

FIG. 11 illustrates other grids of the electron beam generator 2 according to the exemplary embodiment of the present invention. As shown therein, grids according to the present exemplary embodiment are electrically insulated, i.e., a floating grid 121 exists, and electron particles within an electron generator are extracted by a voltage difference between the floating grid 121 and another grid 122. The reason that the insulated float grid 121 is required is as follows. If only a negatively or positively (or grounded) charged grid exists, the electric potential of the negatively-charged grid should be raised to raise the electric potential of the plasma for higher electron energy. However, if the electric potential of the grid is raised, an ark is caused between the grid and an adjacent positive (or grounded) grid, and reaches a limit. To prevent the ark between the two grids, the positive grid is changed to a floating grid. As for another reason, if there is only a negatively or positively-charged grid, part of electron particles returns to the plasma generating chamber 20 to gather in the positive grid or to reduce energy when such electron particles move to the inside of the beam width controller 70 from the plasma generating chamber 20. Accordingly, as shown in (a) in FIG. 11, when not the negatively (or grounded) charged accelerating grid but the insulated grid exists, it is easy to raise the electric potential of the negatively-charged electric potential and more energy may be generated. Also, the electron particles linearly move without any loss since there is no attraction to the back when moving to the inside of the beam width controller 70 after passing through the two grids.

(b) in FIG. 11 is a sectional view of other grids according to the present invention which are formed as a result of the foregoing reasons. As shown therein, the grids according to the present exemplary embodiment include negatively-charged and positively charged grids 123 and 124 disposed sequentially and an additional floating grid which is insulated. In the arrangement of the girds, when the electron particles are discharged from the plasma generating chamber 20 and move to the inside of the beam width controller 70 due to an intense voltage difference between negative and positive grids, the floating grid shields the attraction of the two grids. Accordingly, the electron particles may accelerate by the intense voltage difference between the two grids, and their movement is not restricted by the attraction.

Hereinafter, an electron beam generator according to a second exemplary embodiment of the present invention will be described. The electron beam generator according to the second exemplary embodiment is similar to the electron beam generator according to the first exemplary embodiment except that the shape is a rectangle and a section of an electron beam is rectangular.

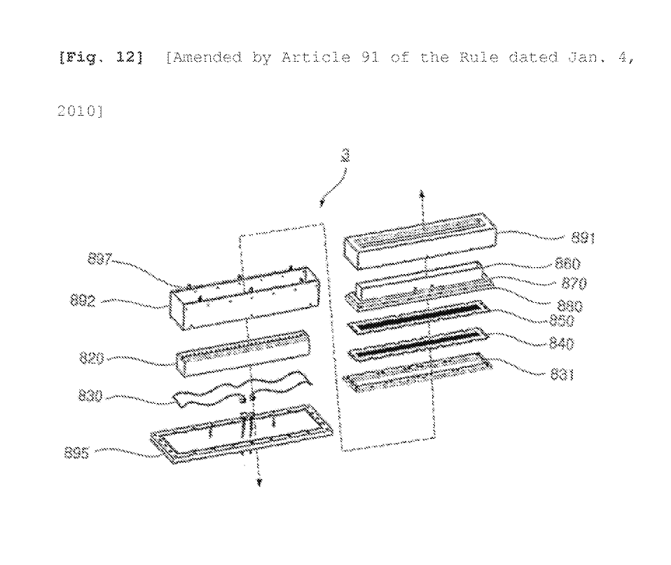

Referring to FIG. 12, an electron beam generator 3 according to the present exemplary embodiment includes a plasma generating chamber 820, an RF antenna 830, a primary grid 840 and a secondary grid 850 provided on a grid supporting ring 831, a beam width controller 860, an RF shield ring 880 cooled by a cooling unit 870, housing units 891 and 892, and a flange 895 supplying power, gas, and cooling water to a vacuum chamber. The electron beam generator 3 extracts electron particles from RF plasma generated within the plasma generating chamber 820 and emits an electron beam to an outlet of the beam width controller 860. The plasma generating chamber 820 contacts the primary grid 840 of the grid supporting ring 831 insulated on a housing flange 897, and the secondary grid 850 and the beam width controller 860 are sequentially disposed.

The electron beam generator 3 according to the second exemplary embodiment includes a plasma generating chamber 830 shaped like a rectangular parallelepiped. The electron beam generator 3 according to the second exemplary embodiment has a different plasma generating chamber and an antenna surrounding the plasma generating chamber from those according to the firs embodiment. Thus, repetitive description will be avoided.

The electron beam generator 3 according to the present exemplary embodiment employs the foregoing plasma generating chamber 820 to emit an electron beam in a rectangular shape in a lengthwise direction. Accordingly, the electron beam generator 3 according to the present exemplary embodiment is appropriate for scanning an electron beam on a surface of a large substrate.

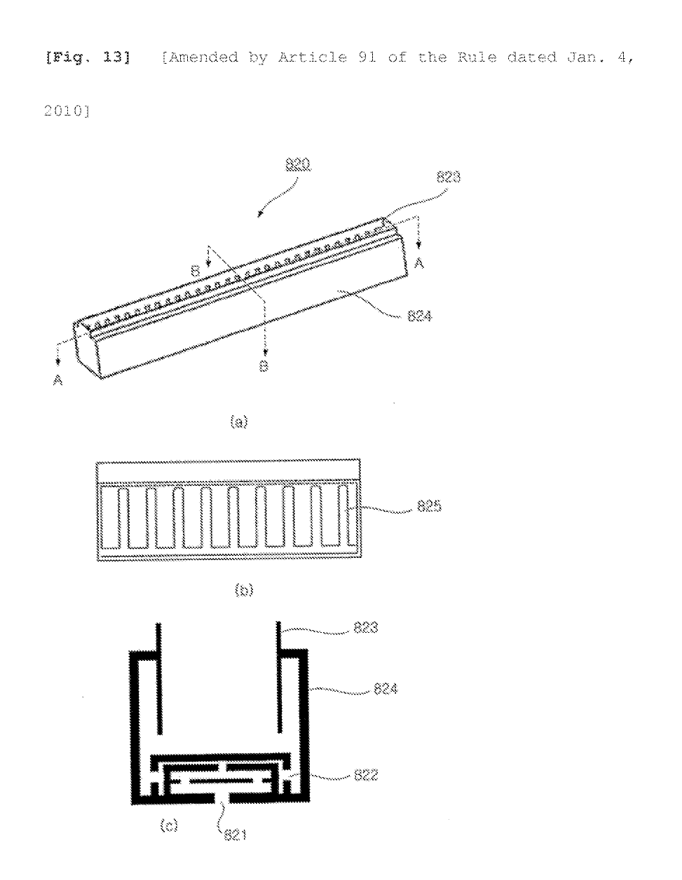

(a) in FIG. 13 is a perspective view of a linear plasma generating chamber shaped like a rectangular parallelepiped and (b) in FIG. 13 is a sectional view taken along line A-A and (c) is a sectional view taken along line B-B. In the present embodiment, the plasma generating chamber is shaped like a rectangular cylinder, but not limited thereto. Alternatively, the plasma generating chamber may be shaped like a polygon. The plasma generating chamber includes the same material as that according to the first embodiment, and includes an external wall, an internal wall, a depressed unit, and a gas inlet which are the same as those according to the first embodiment. As shown in (c) in FIG. 13, the plasma generating chamber includes a depressed unit 821 formed in an inlet, a gas inlet 822 formed in a lateral side of the depressed unit 821, an internal wall 823 and an external wall 824. The internal wall 823 and the external wall 824 are spaced from each other at a predetermined interval, and an end part of the external wall 824 is coupled to an outer circumference of the internal wall 823. The internal wall 823 includes a plurality of openings 825 which is formed in a lengthwise direction of the plasma generating chamber inside the external wall 824.

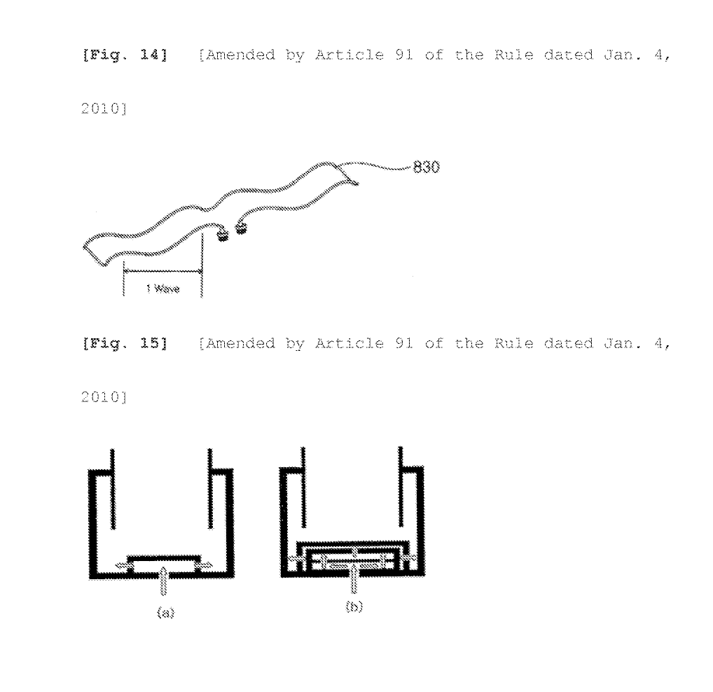

FIG. 14 is a perspective view of an antenna 830 of the electron beam generator 3 according to the present embodiment. The structure and material of the antenna 830 is the same as those according to the first embodiment, and repetitive description will be avoided. The antenna 830 according to the present exemplary embodiment has a wave form to generate plasma from the plasma generating chamber in a rectangular shape.

A wavelength of the antenna 830 is approximately 38 to 54 cm, and the antenna 830 is manufactured in integer times (n=1, 2, 3, 4 . . . ) of this wavelength. Thus, the single wavelength may be divided by positive times. That is, an antenna whose wavelength is 26 cm, ½ of 52 cm wavelength, is also included, and a wavelength which is divided by integer times is also included (inclusive of 38 to 54 cm). If the wavelength of the antenna is reduced by the integer times, the antenna is coiled several times as in the first exemplary embodiment if quartz is shaped like a circle. Then, a density of a magnetic field increases and the density of plasma also increases. That is, one wavelength has the same effect as one coil. This may respond to any wavelength with respect to an increase of the length falling under an integer time of the wavelength or half-wavelength if the rectangular electron beam generator according to the second exemplary embodiment extends in a lengthwise direction.

In addition, as shown in the antenna test result above, such wavelength responds to 38 to 54 cm and may be flexibly applicable depending on the length of quartz or length of the electron beam generator. As a result, the length of the plasma quartz becomes the inter time length of a half-wavelength or one wavelength of the antenna in a wave form, and the antenna which is adjacent to a lateral side of the plasma quartz is shaped in the integer times of the half-wavelength or one wavelength.

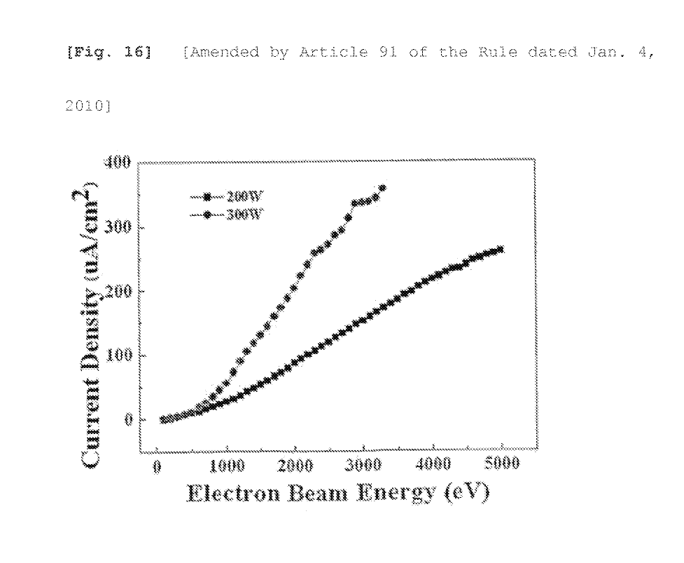

FIG. 15 illustrates a structure of the gas inlet of the plasma generating chamber for a uniform gas injection. The conventional upsized equipment using plasma has weakness in uniformity of density distribution of plasma in a large area. To improve the foregoing problem, various methods are available, including a uniform supply of RF power by changing the structure of the antenna as described above, and uniform injection of gas to the plasma generating chamber. The plasma generating chamber which includes the internal wall 831 with a plurality of openings, the external wall 833, the depressed unit 832, and the gas inlet 834 has the single-step depressed unit receiving gas and allows further gas supplied in a lateral side to maintain uniformity of gas injection volume to thereby uniformize plasma within the plasma generating chamber and the electron beam emitted to the target. As described above, if at least 3KeV high voltage is applied, an ark is caused from the gas inlet. To shield such ark, supply gas uniformly to the chamber and uniformly form a density of plasma in the lengthwise direction according to the increased length of the electron beam generator, the gas inlet should be improved to thereby uniformly supply gas in the lengthwise direction of the electron beam generator. Also, the gas inlet may not include a metal material due to the application of high voltage and safety of plasma, and thus should include quartz or a dielectric such as Pyrex. To solve the foregoing problem, as shown in (b) in FIG. 15, gas is injected to the chamber through a three-step injection structure of the gas inlet including the dielectric. The gas enters the first step of the gas injection structure including the dielectric through at least single input terminal from the rear part of the electron beam, and then two-divided gas gathers in one place by the second step, and then is uniformly injected to both sides of the internal wall of the dielectric. The gas which is uniformly injected by the foregoing structure is converted into plasma with a uniform density by RF power of the antenna. The multi-step structure for uniformly injecting gas may include a single-step, two-step, three-step or four-step structure. The gas inlets cross each other for distribution of the gas.

Although the present invention has been described with reference to the embodiment described above, it is not limited to the embodiment, and the present exemplary invention may be modified in various ways without deviating from the scope of the present invention.

For example, the section of the plasma generating chamber or the beam width controller of the electron beam generator may include a rectangular shape or other shapes in addition to the circular shape to thereby change a sectional profile shape of the electron. The antenna which is disposed in the outer circumference of the chamber may generate transferred coupled plasma (TCP) using an RF coil in the rear part of the flat dielectric on behalf of an inductively coupled plasma (ICP) using an RF coil, generate electron particles or electrons using plasma generated from the RF power applied to the coil in various shapes such as helicon wave and helical wave, generate electron particles or electron using microwave plasma using microwave or ECR plasma, generate electron particles or electron using plasma from a thermoelectron emission plasma using a filament or a hollow cathode electrode or change the trajectory of the beam and flux by changing the bias applied to the beam width controller in positive, negative or a combination of the foregoing type.

It should be construed that the differences in the changes and application as above are included in the scope of the present invention set forth in the accompanying claims.

### INDUSTRIAL APPLICABILITY

An electron beam generator according to the present invention may be widely used in forming a poly silicon thin film, improving the nature of a transparent electrode, treating a surface of a polymer material, processing a metal surface by heat and color and processing a power sintering and a wafer by heat.

1. An electron beam generator comprising:
a plasma generating chamber which comprises a gas inlet and outlet and generates and sustains plasma by using the gas supplied through the gas inlet;
an antenna which is disposed in an outer circumference of the plasma generating chamber and supplies RF power;
a primary grid which is mounted in the outlet of the plasma generating chamber;
a secondary grid which is spaced from the primary grid at a predetermined interval;
a beam width controller which comprises an inlet, an outlet and a hollow unit therein, and the inlet is disposed in the secondary grid, forms an electron beam with a beam width set in advance by electron particles introduced through the inlet, and
the plasma generating chamber, the primary grid, the secondary grid and the beam width controller being arranged on the same axis, and the power applied to the primary grid and the secondary grid to form a potential difference to accelerate electrons, and electron particles being extracted from the plasma generating chamber to be supplied to the outlet of the beam width controller in an electron beam with a preset beam width.

2. The electron beam generator according to claim 1, further comprising an RF shield ring which is disposed in an outer circumference of the inlet of the beam width controller by surrounding the outer circumference of the inlet of the beam width controller and comprises a ferromagnetic material.

3. The electron beam generator according to claim 1, wherein the plasma generating chamber comprises an internal wall and an external wall spaced from the internal wall at a predetermined interval, and the internal wall and the external wall comprise a dielectric.

4. The electron beam generator according to claim 3, wherein the internal wall comprises a plurality of openings formed in a vertical direction of the antenna.

5. The electron beam generator according to claim 1, wherein the antenna has a surface applied with an insulating material.

6. The electron beam generator according to claim 1, wherein the primary grid and the secondary grid comprise one of Si, Mo, Ti, W and carbon.

7. The electron beam generator according to claim 2, further comprising a cooling unit which is provided in a location contacting a lateral side of the RF shield ring.

8. The electron beam generator according to claim 1, wherein the secondary grid comprises a single step or multi-steps.

9. The electron beam generator according to claim 1, further comprising at least one electrode terminal provided in an internal surface of the beam width controller, wherein the beam width controller comprises an insulating material, and adjusts a voltage applied to the electrode terminals to control a beam width of an electron beam.

10. The electron beam generator according to claim 1, further comprising an electrode terminal which is connected to the beam width controller, wherein the beam width controller comprises a conductive material and adjusts a voltage applied to the electrode terminal to control a beam width of an electron beam.

11. The electron beam generator according to claim 1, further comprising a floating grid which is provided between the secondary grid and the beam width controller and is insulated electrically.

12. The electron beam generator according to claim 1, wherein the primary grid comprises a plurality of primary through holes, and a ratio of a diameter of the primary through holes to a thickness of the primary grid is 1:0.5 to 1.

13. The electron beam generator according to claim 1, wherein the secondary grid comprises a plurality of secondary through holes, and a ratio of a diameter of the secondary through holes to a thickness of the secondary grid is 1:1 to 1.2.

14. The electron beam generator according to claim 1, wherein the plasma generating chamber is shaped like a cylinder, and the antenna is coiled several times in an outer circumference of the plasma generating chamber.

15. The electron beam generator according to claim 1, wherein the plasma generating chamber is shaped like a polygon and the antenna is bent and coiled in an external surface of the plasma generating chamber in a lengthwise direction of the plasma generating chamber.

16. The electron beam generator according to claim 15, wherein the antenna is bent so that an integer time of a half-wavelength or one wavelength is disposed in a lateral side of the plasma generating chamber.

17. The electron beam generator according to claim 1, wherein a gas inlet of the plasma generating chamber comprises a single step or multi-steps to uniformly discharge the gas to a lateral side of the lengthwise direction of the plasma generating chamber if the plasma generating chamber is formed in a single direction.

18. The electron beam generator according to claim 1, wherein the beam width controller comprises a metal or ceramic material, floats electrically, and is formed in one of a straight type whose diameter is the same, a focused type whose diameter decreases toward an inlet and a defocused type whose diameter increases toward an outlet.
